(19) United States
(12) Patent Application Publication
(10) Pub. No.: US 2004/0207977 A1
(43) Pub. Date: Oct. 21, 2004

(54) Computer mainframe structure with complex DC and AC power supply

(75) Inventors: Peter Chen, Hsinchuan City (TW); Wen-Tung Chen, Hsinchuang City (TW)

Correspondence Address: BRUCE H. TROXELL, SUITE 1404, 5205 LEESBURG PIKE, FALLS CHURCH, VA, 22041, US

(73) Assignee: Key Mouse Electronic Enterprise Co., Ltd.

(21) Appl. No.: 10/414,151

(22) Filed: Apr. 16, 2003

(51) Int. Cl. G06F 1/16

(52) U.S. Cl. 361/683

(57) ABSTRACT

Computer mainframe structure with complex DC and AC power supply, including a housing and a co-used power supply module. The respective hardware units of the computer and the co-used power supply module are mounted in the housing. The co-used power supply module is composed of a power supply unit, a relay unit, an overcurrent protection and several sockets arranged on a predetermined section of the housing. By means of the co-used power supply module, DC and AC power can be directly supplied to both the units disposed in the housing and the external peripheral equipment. Also, the peripheral equipment can be synchronously turned on or off along with the computer mainframe.

### BACKGROUND OF THE INVENTION

The present invention is related to a computer mainframe structure with complex DC and AC power supply, which can at the same time supply power for the hardware units in the computer housing and external peripheral equipment.

The conventional computer housings can be substantially divided into desktop type, network servo type, large-size operation computer, etc.

The computer housing has a rear protective board and a front panel which define an internal space. The internal space includes a main board section, disc drive section, speaker section, power supply section, etc. Accordingly, the respective components can be arranged in the computer housing in order.

Many improvements of computer housing structure have been disclosed. For example, Taiwanese Patent Application No. 89222652 discloses a latch structure for upper cover of a computer, Taiwanese Patent Application No. 90208626 discloses a computer mainframe housing structure, Taiwanese Patent Application No. 90217350 discloses a connecting device for inner frame of computer mainframe housing, Taiwanese Patent Application No. 88221469 discloses an assembling structure for bracket of computer housing and hardware and Taiwanese Patent Application No. 89206299 discloses an improved computer mainframe housing structure.

The above Patent Applications fail to disclose any connecting or expanding structure for mounting power supply on the computer housing. Conventionally, the power supply is simply arranged in a predetermined position in the computer housing to supply power for some units of the computer. The power supply is not specially connected with the computer housing or designed with changeable function. Moreover, the power supply lacks expandability.

The connection between the computer housing and the power supply can be redesigned to enhance the function and widen the application range thereof. For example, the power supply can be combined with a part of the computer housing in accordance with actual requirement. In addition, the power supply can be expanded to supply other variety of power. Accordingly, the internal components and peripheral equipment of the computer can be all powered from the computer housing without using random external power cable.

### SUMMARY OF THE INVENTION

It is therefore a primary object of the present invention to provide a computer mainframe structure. A co-used power supply module is mounted in the computer housing. By means of the co-used power supply module, the power can be directly supplied to both the units disposed in the housing and the external peripheral equipment. This saves the cost for the transformers and extension cables of the peripheral equipment. Also, the peripheral equipment can be synchronously turned on or off along with the computer mainframe.

According to the above object, the computer mainframe structure with complex DC and AC power supply of the present invention includes a housing and a co-used power supply module. The housing has an internal space in which respective hardware units (such as main board, disc drive and speaker) of the computer and the co-used power supply module are mounted. The co-used power supply module is composed of a power supply unit, a relay unit, an overcurrent protection and several sockets arranged on a predetermined section of the housing. The power supply unit includes a power circuit, a controlling circuit and at least two power output circuits for supplying DC and AC power. The power output circuit outputting AC power is connected with the relay unit, overcurrent protection and the sockets. The plugs of external peripheral equipment can be directly plugged into the sockets, whereby the units disposed in the housing and the external peripheral equipment can be both powered on from the computer housing and the peripheral equipment can be synchronously turned on or off along with the computer mainframe.

The present invention can be best understood through the following description and accompanying drawings wherein:

### BRIEF DESCRIPTION OF THE DRAWING

FIG. 1 is a block diagram of the structure of the present invention.

### DETAILED DESCRIPTION OF THE PREFERRED EMBODIMENT

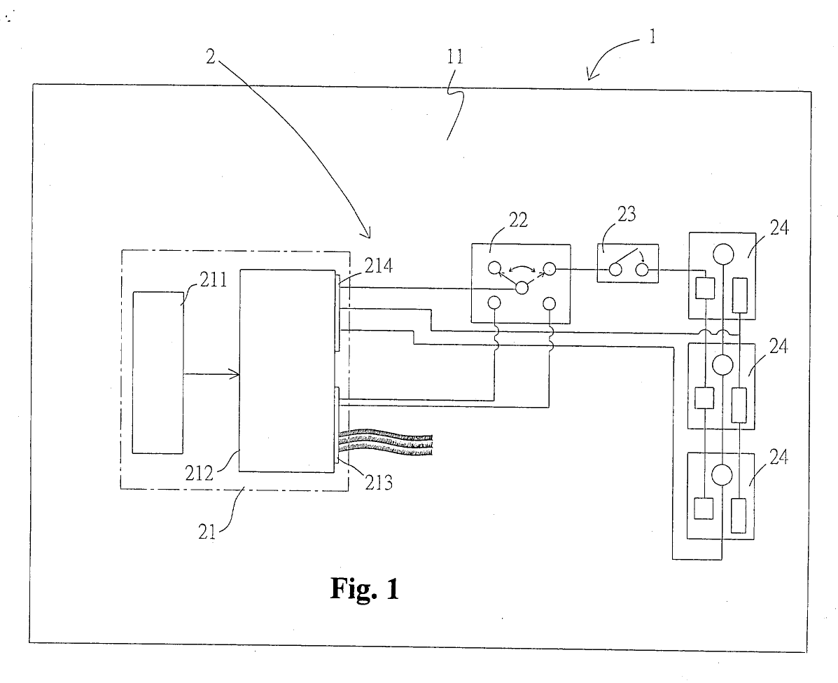

Please refer to FIG. 1. The computer mainframe structure with complex DC and AC power supply of the present invention includes a housing 1 and a co-used power supply module 2. The housing 1 has at least one internal space 11 in which the respective hardware units of the computer (such as main board, disc drive and speaker) are mounted.

The co-used power supply module 2 is composed of a power supply unit 21, a relay unit 22, an overcurrent protection 23 and several sockets 24. The power supply unit 21 includes a power circuit 211, a controlling circuit 212 and at least two power output circuits 213, 214. The power circuit 211 transmits civil power (90V˜225V) to the controlling circuit 212. The controlling circuit 212 rectifies the power and then the two power output circuits 213, 214 output the power.

One power output circuit 213 outputs DC power for the respective hardware units inside the housing 1 such as the main board, disc drive and speaker. The other power output circuit 214 outputs AC power and is connected with the relay unit 22, overcurrent protection 23 and sockets 24. The on/off states of the relay unit 22 are controlled by the controlling circuit 212. When the relay unit 22 is turned on, the circuit is closed, permitting the AC power to reach the sockets 24.

Reversely, when the relay unit 22 is turned off, the circuit is opened and the AC power is cut off from the sockets 24. In addition, in the case of override or unstable current, the overcurrent protection 23 will stop supplying AC current to the sockets 24. Under such circumstance, the sockets 24 cannot provide power to ensure safety.

The sockets 24 are arranged on a predetermined section of the housing 1 (not shown). Preferably, the predetermined section is positioned on rear side of the housing 1 near the signal ports such as USB port, keyboard port and mouse port. Accordingly, most of the cables of the housing 1 are collectively placed in the same position or within smaller range so as to keep the cables tidy.

The relay unit 22 can be a mechanical relay or a semiconductor relay. The overcurrent protection 23 can be formed of a fuse, a fuseless switch or a self-restoring fuse.

The power plugs of the peripheral equipment such as printer, speaker, scanner and panel can be directly plugged into the sockets 24. When the power supply 21 of the computer mainframe is turned on, the controlling circuit 212 will close the relay unit 22 which supplies power to the overcurrent protection 23 and the sockets 24. Accordingly, the peripheral equipment connected with the sockets 24 can be powered on. Reversely, when the power supply 21 of the computer mainframe is turned off, the relay unit 22 will automatically open and the power is cut off from the sockets 24. At this time, the peripheral equipment is powered off.

Accordingly, when the power supply of the computer mainframe is turned on or off, the peripheral equipment is synchronously turned on or off. In case of overcurrent, the overcurrent protection unit 23 immediately cut off the power in very short time so as to ensure safety.

The computer mainframe structure with complex DC and AC power supply of the present invention can at the same time supply power for the hardware units in the housing and external peripheral equipment. This saves the cost for the transformers and extension cables of the peripheral equipment. Also, the peripheral equipment can be synchronously turned on or off along with the computer mainframe.

The above embodiment is only used to illustrate the present invention, not intended to limit the scope thereof. Many modifications of the above embodiment can be made without departing from the spirit of the present invention.

What is claimed is:

1. Computer mainframe structure with complex DC and AC power supply, comprising a housing and a co-used power supply module, the housing having at least one internal space in which respective units of the computer and the co-used power supply module are mounted, said computer mainframe structure being characterized in that the co-used power supply module is composed of a power supply unit, a relay unit, an overcurrent protection and several sockets arranged on a predetermined section of the housing, the power supply unit including power output circuits for supplying DC and AC power, the power output circuit outputting AC power being connected with the relay unit, overcurrent protection and the sockets, whereby the plugs of external peripheral equipment can be directly plugged into the sockets, whereby the units disposed in the housing and the external peripheral equipment can be both powered on from the computer housing and the peripheral equipment can be synchronously turned on or off along with the computer mainframe.

2. Computer mainframe structure with complex DC and AC power supply as claimed in claim 1, wherein the power supply unit includes a power circuit, a controlling circuit and at least two power output circuits, the power circuit transmitting civil power to the controlling circuit, the controlling circuit processing the power and then the two power output circuits respectively outputting AC and DC power.

3. Computer mainframe structure with complex DC and AC power supply as claimed in claim 1, wherein the relay unit is a mechanical relay or a semiconductor relay.

4. Computer mainframe structure with complex DC and AC power supply as claimed in claim 1, wherein the on/off states of the relay unit are controlled by the controlling circuit.

5. Computer mainframe structure with complex DC and AC power supply as claimed in claim 3, wherein the on/off states of the relay unit are controlled by the controlling circuit.

6. Computer mainframe structure with complex DC and AC power supply as claimed in claim 5, wherein when the relay unit is turned on, the power between the controlling circuit and the sockets is simultaneously supplied.

7. Computer mainframe structure with complex DC and AC power supply as claimed in claim 5, wherein when the relay unit is turned off, the power between the controlling circuit and the sockets is simultaneously cut off.

8. Computer mainframe structure with complex DC and AC power supply as claimed in claim 1, wherein the overcurrent protection is formed of a fuse, a fuseless switch or a self-restoring fuse, whereby in the case of override of the AC power output circuit or unstable current, the overcurrent protection cuts off the power.

9. Computer mainframe structure with complex DC and AC power supply as claimed in claim 1, wherein the sockets are arranged on a predetermined section of the housing near the signal ports.
